(19) United States
(12) Patent Application Publication
(10) Pub. No.: US 2025/0267477 A1
(43) Pub. Date: Aug. 21, 2025

(54) TECHNIQUES FOR HANDLING RADIO ACCESS NETWORK FAILURES IN A MOBILE NETWORK ENVIRONMENT

(71) Applicant: Cisco Technology, Inc., San Jose, CA (US)

(72) Inventors: Jis Abraham, Bangalore (IN); Nikhil Rahul Ekka, Bahu Bazar (IN)

(21) Appl. No.: 18/443,636

(22) Filed: Feb. 16, 2024

(51) Int. Cl. H04W 24/02; H04W 84/02

(52) U.S. Cl. CPC H04W 24/02; H04W 84/022

(57) ABSTRACT

Provided herein are techniques to facilitate handling Radio Access Network (RAN) failures in a mobile networking environment. In one example, a method may include obtaining, by an access management node from a session management node of a mobile network, a subscription request for the session management node to be notified regarding reset of a radio node of a wireless wide area (WWA) radio access technology (RAT) type; determining, by the access management node, that a particular radio node of the WWA RAT type has been reset; and providing, by the access management node to the session management node, a notification indicating that the particular radio node of the WWA RAT type has been reset.

### TECHNICAL FIELD

The present disclosure relates to network equipment and services.

### BACKGROUND

Networking architectures have grown increasingly complex in communications environments, particularly mobile networking environments. Mobile communication networks have grown substantially as end users become increasingly connected to mobile network environments. As the number of end users increases, management of communication resources for a mobile network and for user equipment becomes more critical.

### BRIEF DESCRIPTION OF THE DRAWINGS

FIG. 1 is a message sequence diagram illustrating operations that are conventionally performed in a mobile network environment upon occurrence of a Radio Access Network (RAN) failure.

FIG. 2 illustrates a system that may be provided for handling Radio Access Network (RAN) failures in a mobile network environment, according to an example embodiment.

FIG. 3 is a message sequence diagram illustrating example operations that may be utilized for handling RAN failures in a mobile network environment, according to an example embodiment.

FIG. 4 is a flow chart depicting a method according to an example embodiment.

FIG. 5 illustrates a hardware block diagram of a computing device configured to perform functions associated with operations discussed in connection with embodiments herein.

### DETAILED DESCRIPTION

### Overview

Embodiments herein provide techniques for handling Radio Access Network (RAN) failures in a mobile network environment. For mobile network environments involving Third Generation Partnership Project (3GPP) Fifth Generation (5G)/New Radio (NR) Radio Access Technology (RAT) types, embodiments herein may facilitate optimized RAN handling operations. More specifically, embodiments herein may facilitate optimizing communications between an Access and Mobility Management Function (AMF) and a Session Management Function (SMF) for scenarios in which a 5G radio node, typically referred to as a ‘gNodeB’ or ‘gNB’, and/or any other next generation (nG) radio node, has failed in a RAN.

In at least one embodiment, a computer-implemented method is provided that may include obtaining, by an access management node from a session management node of a mobile network, a subscription request for the session management node to be notified regarding reset of a radio node of a wireless wide area (WWA) radio access technology (RAT) type; determining, by the access management node, that a particular radio node of the WWA RAT type has been reset; and providing, by the access management node to the session management node, a notification indicating that the particular radio node of the WWA RAT type has been reset.

### Example Embodiments

In current mobile core network architectures (e.g., as defined per 3GPP Technical Specification (TS) 23.501), an N11 interface is defined to facilitate connection/communications between an Access and Mobility Management Function (AMF) and a Session Management Function within a Third Generation Partnership Project (3GPP) 5G core (5GC) network.

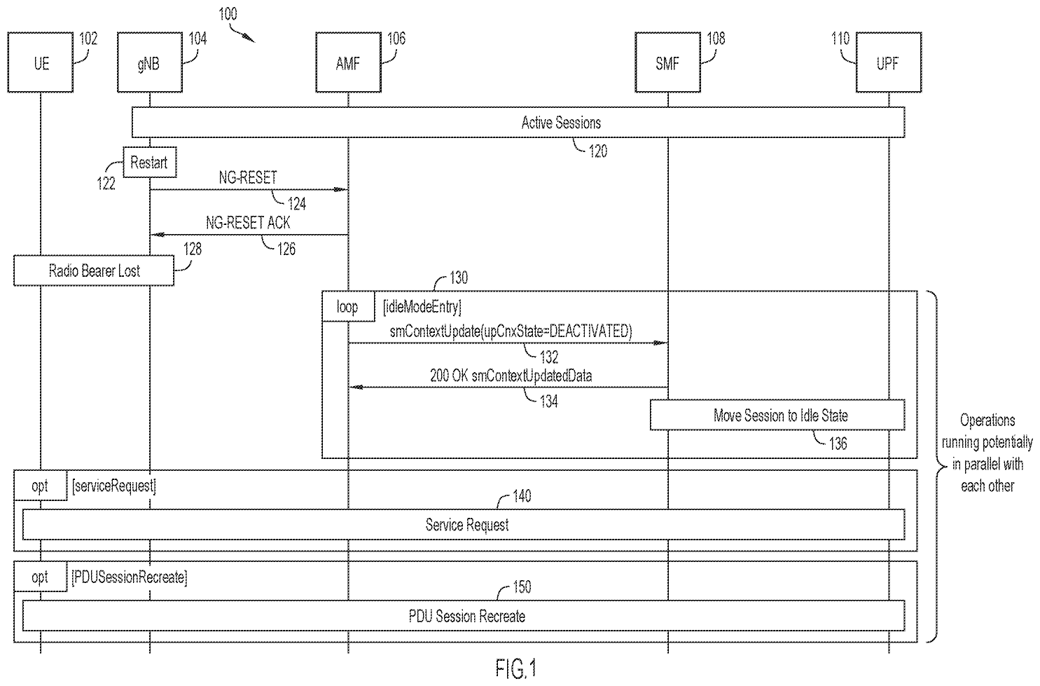

FIG. 1 is a message sequence 100 diagram illustrating operations that are conventionally performed in a mobile network environment upon occurrence of a RAN failure. FIG. 1 includes a user equipment (UE) 102, a gNB 104, an AMF 106, an SMF 108, and a User Plane Function (UPF) 110.

As generally shown at 120, consider that there are a number of active Protocol Data Unit (PDU) sessions handled by gNB 104 and UPF 110 in which management of the sessions may involve coordination between AMF 106 and SMF 108, including a PDU session for UE 102, for example. As generally illustrated at 122, the gNB 104 may experience a reset scenario/condition. There can be different scenarios in which a 5G RAN or, more specifically, one or more radio nodes of the 5G RAN for the 5G/New Radio (NR) Radio Access Technology (RAT) type, such as gNB 104, may be reinitialized and/or may be restarted/reset (e.g., due to software upgrades, power cycling, power failures, etc.). Upon re-initialization, the RAN/radio nodes can inform the AMF 106 about the reinitialization/restart via a next generation reset (NG-RESET) procedure, as generally shown at 124 and 126 in which, upon restart, gNB 104 sends an NG-RESET message to AMF 106, which AMF 106 acknowledges (ACK).

Conventionally, upon being notified of a gNB reset, such as reset of gNB 104, an AMF, such as AMF 106, can trigger a session management (SM) context update procedure (smContextUpdate) being performed by the AMF 106, as generally shown at 130, through which the AMF 106 can trigger idle mode entry for each UE PDU session of the multiple PDU sessions of UEs (e.g., UE 102) that may be hosted via SMF 108 on the gNB 104 that was reset. For example, as shown at 132, the AMF 106 can indicate deactivation of the user plane (up) context (upCnxState=deactivated), also referred to as idle mode entry, for each of multiple PDU sessions of UEs (e.g., UE 102) that may be hosted via SMF 108 for the gNB 104 that was reset (in which data plane connectivity for the UE PDU sessions can be facilitated via a UPF, such as UPF 110). For each UE for which the AMF 106 triggers idle mode entry toward the SMF 108, the SMF 108 can respond to the AMF 106 with a corresponding Hypertext Transfer Protocol (HTTP) “200 OK” message indicating that the context for each UE has been updated (smContextUpdatedData) and the SMF 108, via UPF 110, can move each UE session to the idle state, as shown at 136. The messaging at 132 and 134 can loop/be performed for each of multiple UE PDU sessions handled by the SMF 108.

Additionally, when a RAN/radio node, such as gNB 104 to which UE 102 may be connected for a given PDU session, restarts, the UE 102 detects a radio bearer failure (as generally shown at 128) and initiates a service request towards the SMF 108, as generally shown at 140. In certain scenarios, the UE 102 may trigger a reattach or a PDU re-establishment procedure toward the SMF 108, as generally shown at 150. From the AMF 106 perspective, as the AMF 106 does not handle PDU session management, the AMF 106 does not monitor/analyze Non-Access Stratum-Session Management (NAS-SM) content sent from UE 102 towards the SMF 108 regarding PDU session requests (or NAS messages could be sent via another AMF), which can result in parallel procedures being performed on the N11 interface between the AMF 106 and the SMF 108.

For example, as noted above, upon receiving the NG-RESET indication from the gNB 104 (as shown at 124, for example), the AMF 106 conventionally triggers idle mode entry for the UE 102 towards SMF 108 by sending a session management context update message to the SMF 108 to transition the UE 102 session to idle or “deactivated”, as shown in FIG. 1 at 132 (e.g., sending a corresponding smContextUpdate (upCnxState=deactivated) to the SMF 108), while idle mode exit could be triggered by the UE 102 potentially performing a service request in parallel with the AMF 106 idle mode entry communication toward the SMF 108. Similarly, idle mode entry communications from the AMF 106 and a PDU session create request being sent by the UE 102 could also be triggered in parallel with each other.

The SMF 108 can receive messages from the AMF 106 or the UE 102 in any order or at the same time, which can result in collisions in operations performed by the SMF 108 and, thus, unexpected outcomes. A common outcome is the gNB 104 and the UPF 110 becoming out of synchronization (sync) with each other with regard to the user plane context (upCnxState) state of the UE 102, which could result in additional messaging exchanges between the gNB, the AMF 106, the SMF 108, and the UPF 110 in order to synchronize the UE 102 context state. Such additional messaging could also result in UE 102 experiencing a connectivity glitch with the mobile core network, thus negatively impacting user experience.

Additionally, the current N11 signaling mechanism between the AMF 106 and the SMF 108 involves per-UE session management context update idle mode entry messaging on the N11 interface, meaning that a corresponding smContextUpdate (upCnxState=deactivated) message is sent by the AMF 106 to the SMF 108 (e.g., at 132) and a corresponding response sent from the SMF 108 back to the AMF 106 (e.g., at 134) for each of multiple UEs that may have a PDU session managed by the SMF 108, which is not optimal, as there could be many UEs having sessions handled by a single SMF.

Additionally, such per-UE session management context update idle mode entry signaling by the AMF 106 to trigger idle mode entry per-UE session can introduce delay into core network operations. As the SMF 108/UPF 110 may not be aware of a gNB, downlink data could still be flowing for the sessions that have not yet been marked as idle, which can lead to the gNB 104 sending an error indication to the UPF 110. The UPF 110 on receiving the error indication from the gNB 104 then sends an Error Indication Report (ERIR) to the SMF 108, leading the SMF 108 to start ERIR processing, which can lead to other collisions due to the ongoing per-session signaling being from the AMF 106.

Another possible issue may be created if the UE 102 moves to another gNB and triggers a new service request via the new gNB. Such a scenario could also lead to additional collisions between idle mode entry being received via the old gNB and a (new) service request being received from the new gNB. If the (new) service request reaches the SMF 108 first, then ambiguity may be experienced by the SMF 108 that could introduce session failures.

In order to address such issues, embodiments herein provide for avoiding or eliminating per-session messaging between an AMF and an SMF upon/during a 5G RAN/radio node failure (e.g., for an NG-RESET condition). Broadly, in accordance with embodiments herein, an SMF can subscribe to an AMF for notifications regarding RAN/radio node failures for a RAT type, such as the 5G/NR RAT type provided via one or more gNBs that interface with the AMF, in which the AMF can be notified regarding such RAN/radio node failures via an NG-RESET notification received from a given gNB. Upon determining a RAN/radio node failure of the given 5G/NR RAT type, for example, upon receiving an NG-RESET notification from a gNB of the 5G/NR RAT type, the AMF can determine whether the SMF has subscribed for notifications regarding RAN/radio node failures for the 5G/NR RAT type. Upon determining that the SMF has subscribed for notifications regarding RAN/radio node failures for the 5G/NR RAT type, the AMF can notify the SMF regarding the gNB failure (instead of providing per-UE session idle mode entry notifications to the SMF), thereby avoiding the conventional per-session context update idle mode entry messaging mechanism on the N11 interface between the AMF and the SMF.

Thus, in accordance with embodiments herein, the AMF, based on an SMF subscription to receive notifications of RAN/radio node failures or, more generally, regarding reset of a radio node for a particular RAT type, such as a wireless wide area (WWA) RAT type (e.g., the 5G/NR RAT type), the AMF can send a notification to the SMF regarding reset of the radio node and may abstain from sending per-UE session management context update idle mode entry messaging to the SMF.

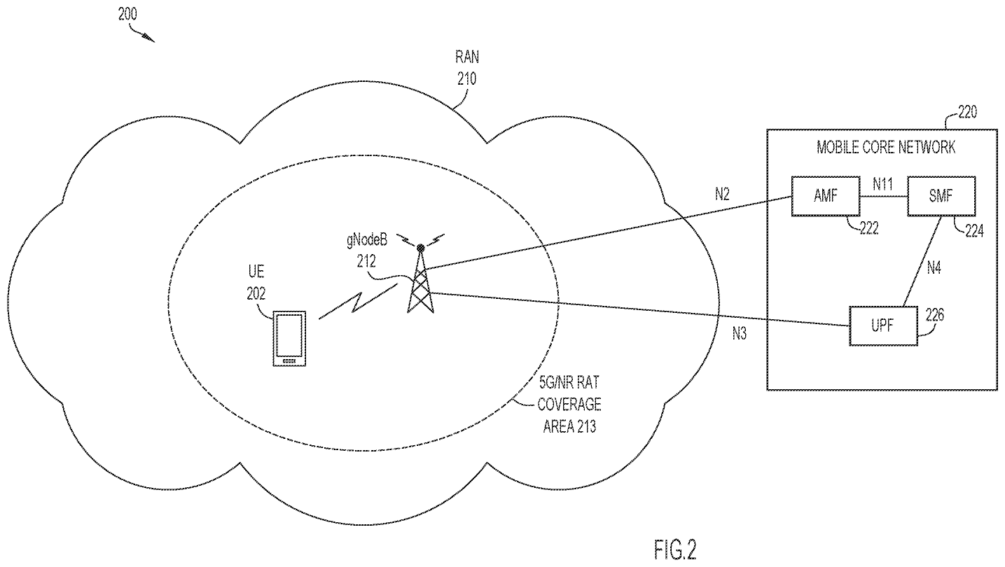

Referring to FIG. 2, FIG. 2 illustrates a system 200 that may be provided for handling Radio Access Network (RAN) failures a mobile network environment, according to an example embodiment. In at least one embodiment, system 200 may include a Radio Access Network (RAN) 210 and a mobile core network 220. Also shown in FIG. 2 is a UE 202. It is to be understood that any number of UEs may be present in system 200.

The RAN 210 may include any number of radio nodes that may provide Radio Frequency (RF) coverage for any combination of Radio Access Technology (RAT) types. In at least one embodiment, RAN 210 may include a 5G/NR radio node, such as a gNB 212, that may provide RF coverage for the 5G/NR RAT type (shown in FIG. 2 as 5G/NR RAT coverage area 213) through which one or more UE, such as UE 202, can establish wireless connectivity with gNB 212 for communications involving mobile core network 220. The configuration of radio nodes for RAN 210, such as gNB 212, is provided for illustrative purposes only and is not meant to limit the broad scope of embodiments herein. It is to be understood that any number of gNBs may be present within system 200. Further, it is to be understood that the size/shape of the coverage area 213 is provided for illustrative purposes only and are not meant to limit the broad scope of embodiments herein.

In accordance with embodiments herein, a 5G/NR RAT type may be considered a wireless wide area (WWA) RAT type, such as a 3GPP cellular RAT type. For example, the 5G/NR RAT type provided by gNB 212 may be considered a 3GPP WWA/cellular 5G/NR RAT type, or more generally, a WWA RAT type, which may be distinguished from/considered different from wireless local area (WLA) RAT types, such as Institute of Electrical and Electronics Engineers (IEEE) 802.11 (e.g., Wi-Fi®) RAT types.

Regarding mobile core network 220, mobile core network 220 may include any number of physical and/or virtualized network functions (VNFs) for providing 5G and, in some instances, Fourth Generation/Long Term Evolution (4G/LTE) mobile core network functionality within system 200. For example, in at least one embodiment, mobile core network 220 may be configured with 5G VNFs, such as an Access and Mobility Management Function (AMF) 222, a Session Management Function (SMF) 224, and a User Plane Function (UPF) 226.

It is to be understood that mobile core network 220 may include any other 5G and/or 4G/LTE network functions/functionality, as may be provided by 3GPP standards, such as any number/combination of a Unified Data Management (UDM) entity, a Unified Data Repository (UDR), a Policy Control Function, and/or any other 5G network functionality, as well as any of a Serving Gateway (SGW), a Packet Data Network (PDN) Gateway (PGW), control plane/user plane functionality such as a PGW-C (control plane)/PGW-U (user plane), a SGW-C/SGW-U, a Policy and Charging Rules Function (PCRF), a Home Subscriber Service (HSS), and/or any other 4G/LTE network functionality. Such network functionality is not shown in FIG. 2 for purposes of brevity only in order to illustrate other features of embodiments herein and is not meant to limit the broad scope of the teachings of embodiments herein.

Generally, for mobile core network 220, AMF 222 may interface with SMF 224 via a 3GPP N11 interface, and AMF 222 may interface with gNB 212 via a 3GPP N2 interface. SMF 224 may further interface with UPF 226 via a 3GPP N4 interface and UPF 226 may further interface with gNB 212 via a 3GPP N3 interface. Other interfaces may be facilitate/provided between/among various elements of system in accordance with any 3GPP standards, such as 3GPP TS 23.501, 23.502, etc.

During operation of system 200, embodiments herein provide for avoiding or eliminating per-UE session management context update idle mode entry messaging between the AMF 222 and SMF 224 upon/during a 5G/NR RAN/radio node failure and reset (e.g., for an NG-RESET condition). Broadly, in accordance with embodiments herein, SMF 224 can subscribe to AMF 222 for notifications regarding RAN/radio node failure/reset indications for a RAT type, such as the 5G/NR (e.g., WWA) RAT type provided via one or more gNBs that interface with the AMF 222, such as gNB 212 providing the 5G/NR RAT coverage area 213 that interfaces with AMF 222.

The AMF 222 can be notified regarding such 5G/NR RAN/radio node failures and reset via an NG-RESET notification received from the gNB 212. Upon determining a RAN/radio node failure and corresponding reset (e.g., upon receiving an NG-RESET notification from gNB 212 of the 5G/NR RAT type), the AMF 222 can determine whether the SMF 224 has subscribed for notifications regarding RAN/radio node failures/reset for the 5G/NR RAT type. Upon determining that the SMF 224 has subscribed for notifications regarding RAN/radio node failures for the 5G/NR RAT type, the AMF 222 can notify the SMF regarding the gNB 212 failure (instead of providing per-UE session idle mode entry notifications to the SMF 224), thereby avoiding the conventional per-UE session management context update idle mode entry messaging mechanism on the N11 interface between the AMF 222 and the SMF 224.

Thus, in accordance with embodiments herein, AMF 222 does not notify the SMF 224 with session management context updates regarding idle mode entry for any UE having a PDU session associated with the gNB 212 that has been reset. Stated differently, the AMF 222 abstains from sending session management context update idle mode entry notifications to the SMF 224 for any UEs having a PDU session associated with the gNB 212 that has been reset.

In at least one embodiment, the SMF 224 can utilize a standards-based mechanism as provided in European Telecommunications Standards Institute (ETSI) TS 129 518, such as Version 17.11.0, published in October 2023 (3GPP TS 29.518 Version 17.11.0 Release 17) (or any other appropriate version thereof), in order to subscribe to notifications from the AMF 222 regarding 5G/NR RAN/radio node failures. In at least one embodiment, the subscription toward AMF 222 initiated by the SMF 224 may include the SMF 224 utilizing a “NonUeN2” service provided between the SMF 224 and the AMF 222, as may be prescribed at least by 3GPP TS 29.518, Section 6.1.6.2.10. Generally, the “NonUeN2” service can be used for notifications sent via the N2 interface that are not UE related, such as notifications that can be sent to the AMF 222 via the N2 interface that are RAN related notifications or, more specifically, that may be gNB 212 related and/or other RAN 210 related notifications.

In at least one embodiment, the SMF 224 can subscribe to the AMF 222 for “NonUeN2” events from the AMF 222 for NG-RESET conditions/notifications received by the AMF 222 for the 5G/NR (e.g., WWA) RAT type (e.g., received from gNB 212). The SMF 224 can subscribe to such notifications when the SMF 224 discovers the AMF 222 for the first time.

In at least one embodiment, the SMF 224 can subscribe to notifications involving the NG-RESET condition for the 5G/NR RAT type by sending a “NonUeN2InfoSubscribe” subscription request message to the AMF 222 including a “NonUeN2InfoSubscriptionCreateData” structured data type that includes an access network (an) information element (IE), “anTypeList,” that is populated by the SMF 224 to include/identifies the “NR” RAT type. The SMF 224 can also include an “N2InformationClass” IE in the “NonUeN2InfoSubscriptionCreateData” structured data type for the subscription request in which the “n2InformationClass” IE can be set to “RAN.”

Setting the “N2InformationClass” IE to “RAN” in the subscription request implicitly subscribes the SMF 224 to receive notifications regarding NG-RESET notifications received by the AMF 222 for the NR (5G) RAT type as identified in the “anTypeList” IE included in the subscription request. The SMF 224 also includes an “n2NotifyCallbackUri” IE in the subscription request that provides a callback Uniform Resource Identifier (URI) that the AMF 222 can use to notify the SMF 224 upon receiving an NG-RESET notification from a gNB for the subscribed NR RAT type.

Thereafter, when the AMF 222 receives a reset notification from a radio node of the NR RAT type, such as receiving an NG-RESET notification message from gNB 212 indicating a failure/reset of the gNB, the AMF 222 can determine whether any SMF, such as SMF 224, has subscribed for “NonUeN2” notifications involving the NR RAT type, such as the reset notification sent by gNB 212. Upon determining that SMF 224 has subscribed to such NR RAT type notifications, the AMF 222 can utilize the callback URI that the SMF 224 registered with the AMF 222 as part of the subscription in order to notify the SMF 224 regarding the NR RAN/radio node failure of the gNB 212, or stated differently, can send a RAN/radio node reset notification to the SMF 224 regarding the NG-RESET condition/notification involving gNB 212.

In at least one embodiment, the RAN/radio node reset notification message sent by the AMF 222 to the SMF 224 regarding the gNB 212 failure/reset can be formatted according to the

“N2InformationNotification” structured data type as prescribed at least by 3GPP TS 29.518, Section 6.1.6.2.14. In at least one embodiment, an “n2NotifyCallbackUri” notification message can be used by the AMF 222 to send the notification to the SMF 224 in which the AMF 222 can include in the notification the “N2InformationNotification” data type that includes an “n2InfoContainer” IE that is populated with the “n2InformationClass” set to “RAN” and includes a “ranInfo” IE.

The “ranInfo” IE may include an “n2InfoContent” IE that further includes a Next Generation Application Protocol (NGAP or ngap) “ngapleType” IE that is set to indicate the (type of) N2 notification that was received by the AMF 222 from the gNB 212 via the N2 interface, such as the “NG-RESET” notification receive by the AMF 222, and may the “ranInfo” IE may further include an “ngapData” IE that can be set to identify data/information included in the N2 notification received by the AMF 222, such as the identity of gNB 212, which can be identified using a global RAN node identity (ID) of the gNB 212, also referred herein as “globalGnbld,” such that the global RAN node ID of gNB 212 can be identified in the subscription notification sent by the AMF 222 to the SMF 224. As may be prescribed at least by ETSI TS 138 413, Version 17.6.0, published October 2023 (3GPP TS 38.413 Version 17.6.0 Release 17) (or any appropriate version thereof), §§ 9.3.1.5 and 9.3.1.6, the Global RAN Node ID of a gNB can be derived from the NR Cell Global Identity (NCGI) of the gNB such that the Global RAN Node ID for the gNB is equal to the leftmost bits of an NR Cell Identity of the gNB contained in each NCGI of each cell served by the gNB.

Upon receiving the subscription notification (e.g., RAN/radio node failure/reset notification) from the AMF 222 regarding the NG-RESET of gNB 212, the SMF 224, can use the content of the NG-RESET, such as the global RAN node ID of gNB 212, in order to take action for any UE PDU sessions that may have involve the gNB 212 (e.g., that may have been established via gNB 212). For example, during PDU session creation, the SMF 224 receives user location information from the AMF 222 for the UE for which the session is to be created, such as UE 202, for example. The user location information includes the global RAN node ID of the gNB to which the UE is connected, such as the global RAN node ID of gNB 212. Thus, the SMF 224, using the global RAN node ID of gNB 212 contained in the RAN/radio node failure/reset notification obtained from the AMF 222, can identify all UE PDU session(s) that have been established via the gNB 212. Upon identifying the UE PDU sessions associated with gNB 212, the SMF 224 can then move all the corresponding UE PDU sessions to the idle state and update the UPF 226 regarding such idle state information.

Accordingly, the RAN/radio node failure subscription/notification techniques as provided in accordance with embodiments herein can be utilized to avoid per-UE session management context update idle mode entry messaging on the N11 interface between AMF 222 and SMF 224, which can aid in avoiding collisions on the N11 interface due to potentially overlapping/parallel NG-RESET, UE service request, and/or other messaging as discussed above.

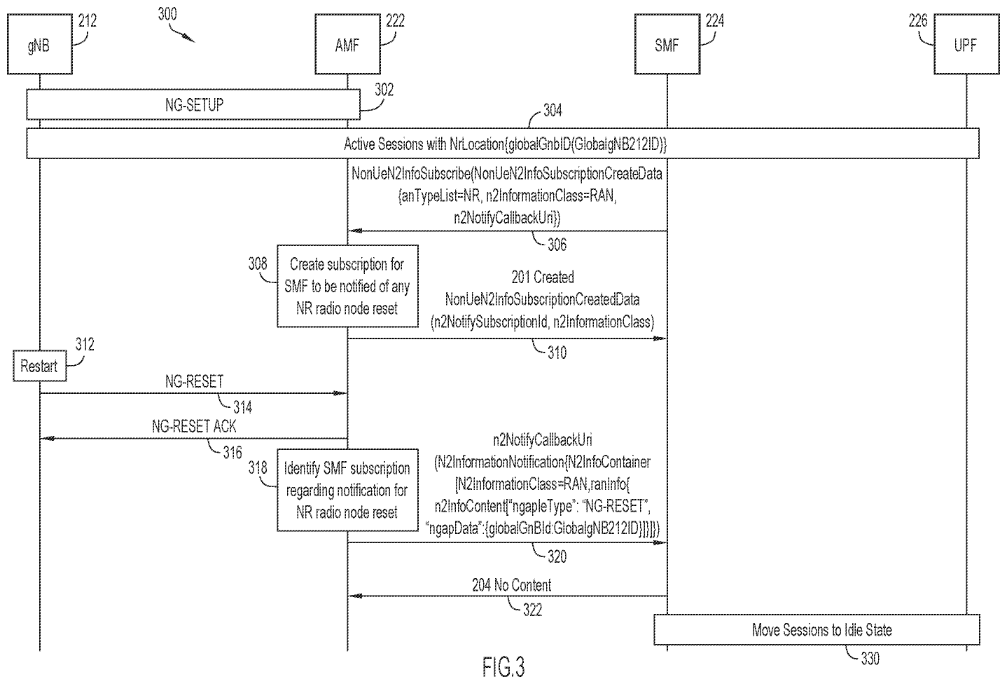

Referring to FIG. 3, FIG. 3 is a message sequence diagram 300 illustrating example operations that may be utilized for handling RAN failures in a mobile network environment, according to an example embodiment. FIG. 3 include gNB 212, AMF 222, SMF 224, and UPF 226.

As shown at 302, consider that a next generation setup (NG SETUP) procedure is performed between gNB 212 and AMF 222, for example, when gNB 212 is onboarded to the AMF 222 such that the global RAN node ID (“globalGnbId,” as shown in FIG. 3) of gNB 212, is learned/obtained by AMF 222. The NG SETUP procedure may be performed in accordance with NG Application Protocol (NGAP or ngap) procedures as may be prescribed at least by ETSI TS 138 413, Version 17.6.0, published October 2023 (3GPP TS 38.413 Version 17.6.0 Release 17) (or any appropriate version thereof).

As shown at 304, consider that a number of active PDU sessions are provided via gNB 212 (e.g., an active PDU session for UE 202, not shown in FIG. 3) in which the sessions are hosted via SMF 224 and UPF 226 such that SMF 224 has identified the globalGnbId (from the NCGI) for gNB 212, such as “GlobalgNB212ID” in the present example, contained in the NrLocation information obtained by the SMF 224 when each PDU session was created (not shown in FIG. 3).

In accordance with embodiments herein, consider at the SMF 224 initiates a subscription request towards AMF 222 to be notified regarding the reset of any radio node of the NR (e.g., WWA) RAT type, such as the reset of gNB 212. Stated differently, the SMF 224 may subscribe to be notified regarding any non-user equipment N2 notifications (nonUeN2 notifications) that may be received by the AMF 222 for the NR RAT TYPE, such as any NG-RESET notifications that may be received by the AMF 222 from any NR gNB, such as gNB 212.

As shown at 306, SMF 224 may subscribe for notifications of the reset of radio node(s) of the NR RAT type by sending a subscription request to AMF 222 in the form of a “NonUeN2InfoSubscribe” message that includes the “NonUeN2InfoSubscriptionCreateData” data type having the “anTypeList” set to “NR” and the “N2InformationClass” IE set to “RAN,” and further including a callback URI of “n2NotifyCallbackUri.”

The subscription request sent to the AMF 222 may be formatted as, “NonUeN2InfoSubscribe(NonUeN2InfoSubscriptionCreateData{an TypeList=NR, n2InformationClass=RAN, n2NotifyCallbackUri}) in one instance, as shown in FIG. 3.

As noted above, setting the “N2InformationClass” IE to “RAN” in the subscription request implicitly subscribes the SMF 224 to receive notifications regarding NG-RESET notifications received by the AMF 222 for the NR (5G) RAT type, as identified in the “anTypeList” IE included in the subscription request.

As generally shown at 308, upon obtaining the subscription request from SMF 224, the AMF 222 creates a subscription for SMF 224 to be notified regarding the reset of any NR radio node and stores the callback URI for the subscription in association with the created subscription. Thus, the AMF 222 may create a subscription for the SMF 224 to be notified regarding any non-user equipment notifications (nonUeN2 notifications). The subscription for the SMF 224 created by the AMF 222 can include a subscription identifier (ID) stored in association with the subscription. Upon creating the subscription for SMF 224, the AMF 222 can respond to the subscription request message from the SMF 224 by sending an HTTP “201 Created” message to the SMF 224, as shown at 310, that includes the subscription ID within an “n2NotifySubscriptionId” IE and includes the “n2InformationClass” IE indicating the subscription being associated with the subscription request sent by the SMF at 306. The subscription response sent to the SMF 224 may be formatted as “201 Created NonUeN2InfoSubscriptionCreatedData (n2NotifySubscriptionId, n2InformationClass)” in one instance, as shown in FIG. 3.

Thereafter, as shown at 312, consider that gNB 212 experiences a failure or other scenario in which the gNB 212 restarts and, as shown at 314, sends a reset notification to the AMF 222, in the form of an NG-RESET message that includes the global RAN node ID of gNB 212 (GlobalgNB212ID, in this example) for the NR RAT type, to which the AMF 222 sends an acknowledgement message (NG-RESET-ACK) to the gNB 212, as shown at 316.

In accordance with embodiments herein, upon receiving the reset notification from the gNB 212 for the NR RAT type, the AMF 222 can determine whether any SMF has a subscription has subscribed for “NonUeN2” notifications regarding the NR RAT type, such as the gNB 212 reset notification received by the AMF 222 via the N2 interface. As shown at 318, the AMF 222 may identify the subscription created for SMF 224 (e.g., at 308) in which the SMF 224 is to be notified regarding a reset of an gNB of the NR RAT type.

Based on identifying NR RAT type subscription for SMF 224, the AMF 222 can notify the SMF 224 that gNB 212 has been reset by sending a reset notification to the SMF 224, as generally shown at 320, using the callback URI received in the subscription request obtained by the AMF 222 at 308.

As shown at 320, the reset notification sent to the SMF 224 can be an “n2NotifyCallbackUri” notification message in which the AMF 222 can include in the reset notification the “N2InformationNotification” data type that includes an “n2InfoContainer” IE that is populated with the “n2InformationClass” set to “RAN” and includes the “ranInfo” IE that may include the “n2InfoContent” IE that further includes the “ngapleType” IE that is set to identify the N2 notification that was received by the AMF 222 via the N2 interface, such “NG-RESET” (the gNB 212 has been reset), and may include the “ngapData” IE that can be set to identify/include information included in the N2 notification received by the AMF 222, such as the identity of gNB 212, such as “globalGnbId: GlobalgNB212ID” identifying the global RAN node ID of gNB 212. The reset notification sent to the SMF 224 may be formatted as “n2NotifyCallbackUri (N2InformationNotification{N2InfoContainer [N2InformationClass=RAN, ranInfo]})” in one instance, as shown in FIG. 3, including the “ranInfo” IE information, as noted above.

The SMF 224 can respond to the reset notification with a HTTP “204 No Content” message, as shown at 322, acknowledging receipt of the reset notification. Further in accordance with embodiments herein, the SMF 224, using the content of the NG-RESET, such as the global RAN node ID of gNB 212 included in the reset notification, can identify any UE PDU sessions associated with gNB 212 (e.g., the PDU session for UE 202) and can then move or transition all corresponding active PDU sessions belonging to gNB 212 to the idle state and update the UPF 226 regarding such the idle state transition, as shown at 330.

Thus, in accordance with embodiments herein, the AMF 222 does not send/avoids sending the SMF 224 per-UE session management context update idle mode entry notifications that would otherwise be sent to an SMF per standards-based procedures, as discussed at 132 for FIG. 1, for example. Stated differently, the AMF 222 may abstain from sending the SMF 224 per-UE session management context update idle mode entry notifications for any UE having a session associated with gNB 212 in accordance with embodiments herein based on the SMF 224 instead subscribing for “NonUeN2” information notifications from the AMF 222.

Accordingly, embodiments herein may significantly reduce the per-UE session management context update idle mode entry messaging on N11 interface between an AMF and SMF for scenarios involving gNB failures/restarts, thus, providing optimized RAN failure handling for the N11 interface. Further, embodiments herein may help to avoid the collision scenarios for UE PDU sessions (e.g., for UE initiated messages such as service requests and/or PDU session create messages, as discussed for FIG. 1, for example), thereby reducing impacts to end users when a gNB fails/restarts. As noted above, the SMF 224, via the reset notification, obtains “NonUeN2” information identifying both the NG-RESET condition and identifying gNB 212 (via the global RAN node ID) from the AMF 222. Thus, even if SMF 224, following receipt of the reset notification from AMF 222 indicating that gNB 212 has been reset, receives a service request from a UE before the SMF 224 has updated the session state for the UE to idle, the SMF 224 knows that the state of the peer/gNB 212 has been reset and can store information indicating the time that the reset occurred; thus, the service request can be easily handled/resolved by the SMF 224 based on the information available at the SMF 224 (e.g., gNB 212 reset time).

Further, embodiments herein may help to reduce the delay in marking PDU sessions as inactive in the UPF (if not already in an idle state), thereby reducing the possibility of data path error indications.

Although the example embodiment of FIG. 3 is discussed with reference to UE PDU sessions involving only one SMF, such as SMF 224, it should be noted that the AMF 222 may send reset notifications to any SMF subscribed to receive such notifications for a given RAT type and that all UE PDU sessions need not be handled by the same SMF and/or UPF but rather may be spread across multiple SMFs/UPFs and/or across multiple AMFs as well (such AMFs also being configured to support embodiments herein).

Although not shown in FIG. 3, the AMF 222 may also mark the mobility management (MM) state of any UE PDU sessions as idle by looping over all sessions that are associate with the gNB 212 and marking the corresponding UE PDU sessions as idle. In some instances, the AMF 222 may notify the SMF 224 once the sessions have been marked idle. The AMF 222 may be capable of appropriately handling any mobility management messages received from any UEs following the reset of the gNB 212 even if the looping procedure is not completed since the AMF 222 has been notified of the gNB 212 reset.

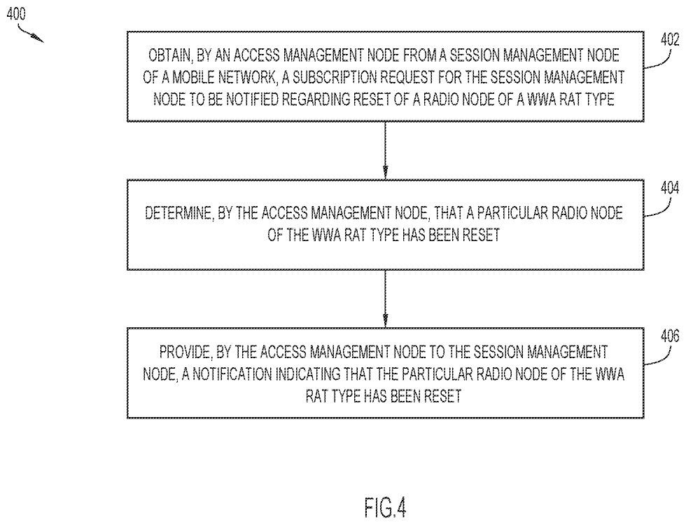

Referring to FIG. 4, FIG. 4 is a flow chart depicting a method 400, according to an example embodiment. In at least one embodiment, method 400 illustrates operations that may be performed by an access management node, such as AMF 222, in order to facilitate handling RAN failures in a mobile network environment, in the mobile network environment of system 200, as shown in FIG. 2, according to an example embodiment.

At 402, the method may include obtaining, by an access management node from a session management node of a mobile network, a subscription request for the session management node to be notified regarding reset of a radio node of a WWA RAT type (e.g., the NR RAT type). The subscription request may include a callback URI that the access management node can use to notify the session management node when the access management node determines that a particular radio node of the WWA RAT type has been reset. In at least one embodiment, the access management node may create a subscription for the session management node to be notified regarding any non-user equipment notifications (nonUeN2 notifications) received by the access management node via an N2 interface associated with the particular WWA RAT type, such as a reset notification (e.g., NG-RESET) received by the access management node via the N2 interface from a radio node of the particular WWA RAT type. A subscription identifier can be stored in association with the subscription created for the session management node.

At 404, the method may include determining, by the access management node, that a particular radio node of the WWA RAT type has been reset. For example, the access management node may receive a reset indication or notification from a particular radio node of the WWA RAT type, such as an NG-RESET notification, as discussed herein, received by the access management node via an N2 interface connection with the particular radio node.

At 406, the method may include providing, by the access management node to the session management node, a notification indicating that the particular radio node of the WWA RAT type has been reset. In at least one embodiment, providing the notification to the session management node may include the access management node identifying the subscription created by the access management node for the session management node to be notified regarding any non-user equipment N2 notifications received by the access management node and, based on the subscription identifier and the callback URI included in the subscription request obtained by the access management node.

The notification sent to the session management node may identify the reset indication that was received by the access management node from the particular radio node (e.g., an NG-RESET notification was received from the particular radio node), and may include information contained in the reset indication that was received by the access management node, such as an identifier of the particular radio node (e.g., the global RAN node ID of the particular radio node).

Accordingly, embodiment herein may significantly reduce the per-UE session management context update idle mode entry messaging on N11 interface for scenarios involving gNB failures/restarts, thus, providing optimized RAN failure handling for the N11 interface.

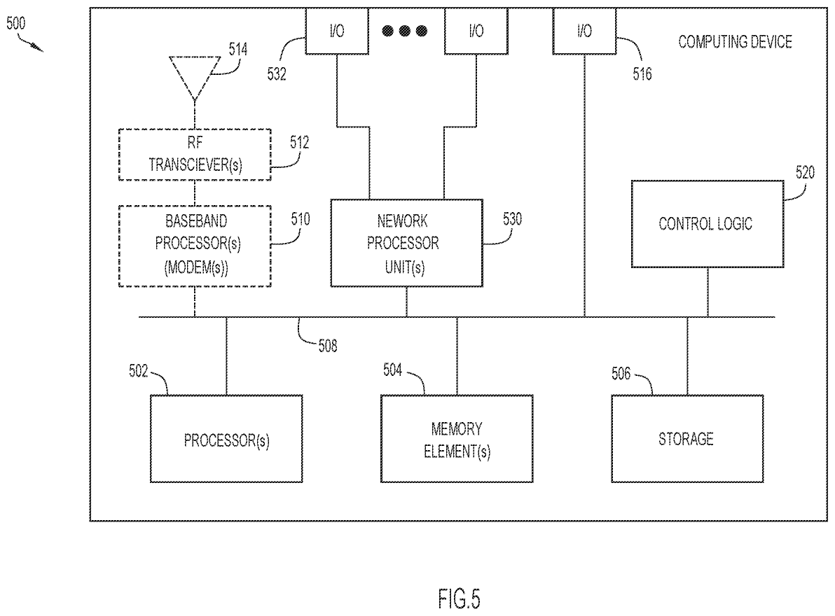

Referring to FIG. 5, FIG. 5 illustrates a hardware block diagram of a computing device 500 that may perform functions associated with operations discussed herein in connection with the techniques described for embodiments herein. In various embodiments, a computing device or apparatus, such as computing device 500 or any combination of computing devices 500, may be configured as any entity/entities in order to perform operations of the various techniques discussed for embodiments herein, such as any elements, functions, etc. discussed for embodiments herein (e.g., UE 202, AMF 222, SMF 224, UPF 226, and gNB 212 of FIGS. 2 and 3).

In at least one embodiment, the computing device 500 may be any apparatus that may include one or more processor(s) 502, one or more memory element(s) 504, storage 506, a bus 508, one or more network processor unit(s) 530 interconnected with one or more network input/output (I/O) interface(s) 532, one or more I/O interface(s) 516, and control logic 520. In various embodiments, instructions associated with logic for computing device 500 can overlap in any manner and are not limited to the specific allocation of instructions and/or operations described herein.

For embodiments in which computing device 500 may be implemented as any device capable of wireless communications, computing device 500 may further include at least one baseband processor or modem 510, one or more radio RF transceiver(s) 512 (e.g., any combination of RF receiver(s) and RF transmitter(s)), one or more antenna(s) or antenna array(s) 514.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 404 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa) or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 530 may enable communication between computing device 500 and other systems, entities, etc., via network I/O interface(s) 532 (wired and/or wireless) to facilitate operations discussed for various embodiments described herein. In various embodiments, network processor unit(s) 530 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 532 can be configured as one or more Ethernet port(s), Fibre Channel ports, any other I/O port(s), and/or antenna(s)/antenna array(s) now known or hereafter developed. Thus, the network processor unit(s) 530 and/or network I/O interface(s) 532 may include suitable interfaces for receiving, transmitting, and/or otherwise communicating data and/or information (wired and/or wirelessly) in a network environment.

I/O interface(s) 516 allow for input and output of data and/or information with other entities that may be connected to computing device 500. For example, I/O interface(s) 516 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

For embodiments in which computing device 500 is implemented as a wireless device or any apparatus capable of wireless communications, the RF transceiver(s) 512 may perform RF transmission and RF reception of wireless signals via antenna(s)/antenna array(s) 514, and the baseband processor or modem 510 performs baseband modulation and demodulation, etc. associated with such signals to enable wireless communications for computing device 500.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include obtaining, by an access management node from a session management node of a mobile network, a subscription request for the session management node to be notified regarding reset of a radio node of a wireless wide area (WWA) radio access technology (RAT) type; determining, by the access management node, that a particular radio node of the WWA RAT type has been reset; and providing, by the access management node to the session management node, a notification indicating that the particular radio node of the WWA RAT type has been reset.

In one instance, the access management node does not notify the session management node for session management context updates regarding idle mode entry for any user equipment having a session associated with the particular radio node of the WWA RAT type that has been reset. In one instance, the access management node abstains from sending to the session management node session management context updates regarding idle mode entry for any user equipment having a session associated with the particular radio node of the WWA RAT type that has been reset.

In one instance, the WWA RAT type is a Third Generation Partnership Project (3GPP) Fifth Generation (5G) New Radio (NR) RAT type.

In one instance, the determining includes the access manage node receiving a reset indication from the particular radio node of the WWA RAT type. In one instance, the notification provided to the session management node identifies the reset indication received from the particular radio node and includes an identifier of the particular radio node of the WWA RAT type. In one instance, the reset indication identifies that an NG-RESET notification was received from the particular radio node of the WWA RAT type and the identifier of the particular radio node is a global Radio Access Network (RAN) node identifier of the particular radio node of the WWA RAT type.

In one instance, the method may further include, upon receiving the notification by the session management node indicating that the particular radio node of the WWA RAT type has been reset, causing any user equipment having a protocol data unit (PDU) session associated with the particular radio node of the WWA RAT type to transition to an idle state. In one instance, the access management node is an Access and Mobility Management Function (AMF) and the session management node is a Session Management Function (SMF).

### Variations and Implementations

Generally, per-3GPP standards for a mobile core network, an AMF interfaces with a SMF which can further interface with one or more UPFs. An AMF and an SMF can further interface with a PCF, a UDM/UDR, and various other core network functions via 3GPP Service-Based Interface (SBI) constructs/interfaces and/or any other 3GPP interfaces/reference points. An AMF and a UPF can further interface with a RAN node, such as one or more gNBs or disaggregated RAN components thereof.

One or more wireless device sessions, often referred to as PDU sessions can be established between a wireless device and a UPF for a core network in which the session may be facilitated/managed by an SMF, as is generally understood in the art.

Generally, a radio access may include one or more Radio Access Network (RAN) radio nodes that may implement a wireless wide area (WWA) (e.g., cellular) air interface and, in some instances also a wireless local area (WLA) (e.g., Wi-Fi®) air interface, for any combination of Radio Access Technology (RAT) types (e.g., ‘accesses’), such as 3GPP WWA licensed spectrum accesses (e.g., Fourth Generation/Long Term Evolution (4G/LTE), 5G/New Radio (NR) accesses); 3GPP unlicensed spectrum accesses (e.g., Licensed-Assisted Access (LAA), enhanced LAA (eLAA), further enhanced LAA (feLAA), and New Radio Unlicensed (NR-U)); non-3GPP licensed/unlicensed spectrum wireless local area (WLA) accesses such as Institute of Electrical and Electronics Engineers (IEEE) 802.11 (e.g., Wi-Fi®); IEEE 802.16 (e.g., WiMAX®), Near Field Communications (NFC), Bluetooth®, and/or the like; Citizens Broadband Radio Service (CBRS) accesses; combinations thereof; and/or the like.

Thus, a WWA RAN radio node may be inclusive of any configuration/combination of 3GPP 4G/LTE evolved Node Bs (eNBs or eNodeBs), 5G next Generation Node Bs (gNBs or gNodeBs), and/or any other next Generation access nodes that may include hardware and/or software to perform baseband signal processing (such as modulation/demodulation) as well as hardware (e.g., baseband processors (modems), transmitters and receivers, transceivers, and/or the like)), software, logic and/or the like to facilitate signal transmissions and signal receptions via antenna assemblies (not shown) in order to provide over-the-air Radio Frequency (RF) coverage for one or more access types (e.g., 4G/LTE, 5G, nG, CBRS, etc.) through which one or more wireless devices, may utilize to connect for one or more sessions (e.g., voice/IMS, data/internet (e.g., video, gaming, etc.), combinations thereof, etc.).

A wireless device, such as UE 102, or any other wireless devices discussed herein, may be considered any electronic device, etc. that initiates a connection or communication session with a corresponding core network, and may be inclusive of but not limited to a computer, a mobile phone or mobile communication device, an electronic tablet, a laptop, etc., an electronic device such as an industrial device (e.g., a robot), automation device, enterprise device, appliance, Internet of Things (IoT) device, a router or gateway with a WWA/WLA interface, a WWA/WLA (cellular/Wi-Fi®) enabled device, and/or any other device, component, element, or object capable of initiating voice, audio, video, media, or data exchanges within a system. Thus, a UE may include any hardware and/or software to perform baseband signal processing (such as modulation/demodulation) as well as hardware (e.g., baseband processors (modems), transmitters and receivers, transceivers, and/or the like), software, logic and/or the like to facilitate signal transmissions and signal receptions via antenna assemblies (not shown) in order to connect to one or more radio nodes of one or more RAN(s).

Generally, an AMF may facilitate access and mobility management control/services for one or more wireless devices seeking connection to/connected to a mobile core network. Generally, an SMF may be responsible for wireless device session management, with individual functions/services being supported on a per-session basis in order to facilitate data transfer(s) between a wireless device and one or more networks via one or more UPFs. Generally, a UPF may operate to provide packet routing and forwarding operations for user data traffic and may also perform a variety of functions such as packet inspection, traffic optimization, Quality of Service (QoS), policy enforcement and user data traffic handling (e.g., to/from one or more data networks), billing operations (e.g., accounting, etc.), among other operations, for wireless device sessions. Typically, a UDM stores subscription data (typically in combination with a UDR) for subscribers (e.g., a user that may be associated with a given wireless device) that can be retrieved and/or otherwise obtained/utilized during operation of a core network system. Typically, a PCF stores policy data in order to provide policy control services (e.g., to facilitate access control, network selection, etc.). Typically, a charging function (CHF) provides support for charging services such as facilitating the transfer of policy counter information associated with subscriber (e.g., UE) spending limits, etc.

In general, authentication services may include authenticating and/or authorizing one or more device(s) for one or more connections and/or communications and may be inclusive of any Authentication, Authorization, and Accounting (AAA) services that may be facilitated via any combination of authentication/authorization protocols such as Remote Authentication Dial-In User Service (RADIUS), DIAMETER, Extensible Authentication Protocol (EAP) [including any EAP variations], and/or the like. Generally, authentication refers to a process in which an entity's identity is authenticated, typically by providing evidence that it holds a specific digital identity such as an identifier/identity and corresponding credentials/authentication attributes/etc. Generally, authorization can be used to determine whether a particular entity is authorized to perform a given activity.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (Ipv4) and/or IP version 6 (Ipv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining, by an access management node from a session management node of a mobile network, a subscription request for the session management node to be notified regarding reset of a radio node of a wireless wide area (WWA) radio access technology (RAT) type;
determining, by the access management node, that a particular radio node of the WWA RAT type has been reset; and
providing, by the access management node to the session management node, a notification indicating that the particular radio node of the WWA RAT type has been reset.

2. The method of claim 1, wherein the access management node does not notify the session management node for session management context updates regarding idle mode entry for any user equipment having a session associated with the particular radio node of the WWA RAT type that has been reset.

3. The method of claim 1, wherein the WWA RAT type is a Third Generation Partnership Project (3GPP) Fifth Generation (5G) New Radio (NR) RAT type.

4. The method of claim 1, wherein the determining includes the access manage node receiving a reset indication from the particular radio node of the WWA RAT type.

5. The method of claim 4, wherein the notification provided to the session management node identifies the reset indication received from the particular radio node and includes an identifier of the particular radio node of the WWA RAT type.

6. The method of claim 5, wherein the reset indication identifies that an NG-RESET notification was received from the particular radio node of the WWA RAT type and the identifier of the particular radio node is a global Radio Access Network (RAN) node identifier of the particular radio node of the WWA RAT type.

7. The method of claim 1, further comprising:
upon receiving the notification by the session management node indicating that the particular radio node of the WWA RAT type has been reset, causing any user equipment having a protocol data unit (PDU) session associated with the particular radio node of the WWA RAT type to transition to an idle state.

8. The method of claim 1, wherein the access management node is an Access and Mobility Management Function (AMF) and the session management node is a Session Management Function (SMF).

9. One or more non-transitory computer readable storage media encoded with instructions that, when executed by a processor, cause the processor to perform operations, comprising:
obtaining, by an access management node from a session management node of a mobile network, a subscription request for the session management node to be notified regarding reset of a radio node of a wireless wide area (WWA) radio access technology (RAT) type;
determining, by the access management node, that a particular radio node of the WWA RAT type has been reset; and
providing, by the access management node to the session management node, a notification indicating that the particular radio node of the WWA RAT type has been reset.

10. The media of claim 9, wherein the access management node does not notify the session management node for session management context updates regarding idle mode entry for any user equipment having a session associated with the particular radio node of the WWA RAT type that has been reset.

11. The media of claim 9, wherein the determining includes the access manage node receiving a reset indication from the particular radio node of the WWA RAT type.

12. The media of claim 11, wherein the notification provided to the session management node identifies the reset indication received from the particular radio node and includes an identifier of the particular radio node of the WWA RAT type.

13. The media of claim 12, wherein the reset indication identifies that an NG-RESET notification was received from the particular radio node of the WWA RAT type and the identifier of the particular radio node is a global Radio Access Network (RAN) node identifier of the particular radio node of the WWA RAT type.

14. A system comprising:
at least one memory element for storing data; and
at least one processor for executing instructions associated with the data, wherein executing the instructions causes the system to perform operations, comprising:
obtaining, by an access management node from a session management node of a mobile network, a subscription request for the session management node to be notified regarding reset of a radio node of a wireless wide area (WWA) radio access technology (RAT) type;
determining, by the access management node, that a particular radio node of the WWA RAT type has been reset; and
providing, by the access management node to the session management node, a notification indicating that the particular radio node of the WWA RAT type has been reset.

15. The system of claim 14, wherein the access management node does not notify the session management node for session management context updates regarding idle mode entry for any user equipment having a session associated with the particular radio node of the WWA RAT type that has been reset.

16. The system of claim 14, wherein the WWA RAT type is a Third Generation Partnership Project (3GPP) Fifth Generation (5G) New Radio (NR) RAT type.

17. The system of claim 14, wherein the determining includes the access manage node receiving a reset indication from the particular radio node of the WWA RAT type.

18. The system of claim 17, wherein the notification provided to the session management node identifies the reset indication received from the particular radio node and includes an identifier of the particular radio node of the WWA RAT type.

19. The system of claim 18, wherein the reset indication identifies that an NG-RESET notification was received from the particular radio node of the WWA RAT type and the identifier of the particular radio node is a global Radio Access Network (RAN) node identifier of the particular radio node of the WWA RAT type.

20. The system of claim 14 wherein executing the instructions causes the system to perform further operations, comprising:
upon receiving the notification by the session management node indicating that the particular radio node of the WWA RAT type has been reset, causing any user equipment having a protocol data unit (PDU) session associated with the particular radio node of the WWA RAT type to transition to an idle state.
